(19) United States
(12) Patent Application Publication
(10) Pub. No.: US 2007/0081510 A1
(43) Pub. Date: Apr. 12, 2007

(54) Method and arrangement for polling management

(76) Inventors: David Bladsjo, GRODINGE (SE); Erik Westerberg, Enskede (SE)

Correspondence Address: NIXON & VANDERHYE, PC, 901 NORTH GLEBE ROAD, 11TH FLOOR, ARLINGTON, VA, 22203, US

(21) Appl. No.: 10/576,873

(22) PCT Filed: Oct. 23, 2003
(86) PCT No.: PCT/SE03/01644

§ 371 Date: Apr. 21, 2006

(51) Int. Cl. H04J 3/16; H04L 12/403

(52) U.S. Cl. 370/346; 370/449

(57) ABSTRACT

In a packet-based communication network (10) polling of connected user equipment is performed according to a first type (T1) and a complementary second type (T2). Upon receiving polling according to type one (T1) a user equipment (30) is allowed to transmit user data packets (UP) if any are available, otherwise the user equipment (30) can remain silent. In response to polling according to type two (T2), the user equipment (30) is required to either transmit an available user data packet (UP) or a dummy data packet (DP).

### TECHNICAL FIELD

The present invention relates to packet-based data communications systems in general, specifically to polling of user equipment in such communications system.

### BACKGROUND

Due to an ever increasing demand for wireless access to mobile applications such as web browsing, e-mail, interactive games, voice services and more, a lot of effort is put into making communications systems that can support those applications. One such system is General Packet Radio Service (GPRS), which is a packet-based data bearer service for GSM (Global System for Mobile communications) and TDMA (Time Division Multiple Access) networks.

GPRS integrates a packet-based wireless interface on the existing circuit switched GSM nerwork. Information is transmitted in packets which are reassembled at the receiving side. Radio resources are used only when packets are being sent or received. This allows multiple users to share the available radio resources, in contrast to circuit switched connections in which each mobile data user is assigned a dedicated channel. As a result an efficient use of the radio spectrum is obtained. Further, the packet-based approach of GPRS allows a seamless connection to the Internet from a mobile personal computer.

Many applications that use these networks require relatively high throughput and are characterized by bursty traffic patterns and asymmetrical throughput needs. In addition, much more information is usually flowing to the client device than is being sent from the client device to the server. In order to further increase the data rates on the radio link a method called EDGE (Enhanced Data rates for GSM Evolution) is utilized.

This add-on introduces a new modulation technique and a new channel coding that can be used to transmit both packet-switched and circuit-switched voice and data services.

Latency or round-trip time (RTT) is one of the most important system characteristics in GPRS/EDGE systems. The RTT is the time that it takes for a small data packet to traverse the system from the client to the server and back to the client. The RTT is of fundamental importance to the end-user experience and the system performance. The smaller the RTT the less time is spent on application-level signaling and higher-level protocol signaling meaning shorter download times and quicker response times in the interactive applications. Consequently, the lower the latency, the better the performance of the applications such as web browsing, e-mail, interactive games, voice services and more.

In the standard for 3GPP (3^{rd} Generation Partnership Project) release 4 (3GPP R4) [1] the feature “extended UL TBF” (or extended uplink temporary block flow) enables the system to pre-reserve uplink resources i.e. radio channels to the mobile station or user equipment. By doing this the set-up time of radio resources is removed from the RTT. In this way the RTT can be reduced from about 450 ms (prior to 3GPP R4) to below about 200 ms (with Extended UL TBF).

One of the problem with the introduction of the UL TBF and the pre-reservation of radio channels or resources is that in order to maintain the pre-reserved resource, the MS is required to transmit an extensive amount of data. This data transmission is mandatory whether or not the MS has any user data to send or not. This leads to large amounts of transmissions of so called dummy data on the uplink (UL).

This also means that there is a high price to pay in terms of battery time in the mobile station and interference or network capacity for realizing the low latency. To put numbers on this, bringing down the latency from 450 ms to 200 ms risks to reduce the battery time by more than 50% and increase the UL interference from the GPRS mobile station with more than 100%.

### SUMMARY

An object of the present invention is accordingly to provide efficient polling management in a packet based data communications system.

Another object is to provide polling functionality in packet-based data communication systems that result in a reduction in latency but not at the expense of increased battery time and/or interference.

These objects are achieved in accordance with the attached claims.

Briefly, the present invention comprises a method of polling that separates the pre-reservation of a shared uplink resource from presence check polling by providing two different types of polling from the base station system. The first type allows the targeted user equipment to transmit user data packets if the user equipment has any packets available for transmission, otherwise the user equipment can remain silent in response to a poll from the base station system. The second type of polling requires the targeted user equipment to transmit user data packets if any are available or transmit dummy data packets if user data packets are not available in order to signal its presence on the pre-reserved resource on the uplink in response to the issued polling, thereby making it possible to monitor the quality of and to maintain the pre-reserved link/channel.

One additional possibility is to perform the two types of polling on two separated logical channels. Also, the base station system can transmit information that alerts the user equipment as to which type of polling is performed.

The present invention offers the following advantages:
increased battery time for connected user equipment,
reduced interference in the communications system.

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of a communications system;

FIG. 2 illustrates a flow diagram over a polling method according to the invention for a base station subsystem,

FIG. 3 illustrates a flow diagram over a polling method according to tha invention for a user equipment,

FIG. 4 illustrates a polling procedure according to an embodiment of the invention,

FIG. 5 is a block diagram of a base station system according to the invention,

FIG. 6 is a block diagram illustrating the polling means of FIG. 2 in more detail,

FIG. 7 is a block diagram of a user equipment according to the invention.

### DETAILED DESCRIPTION

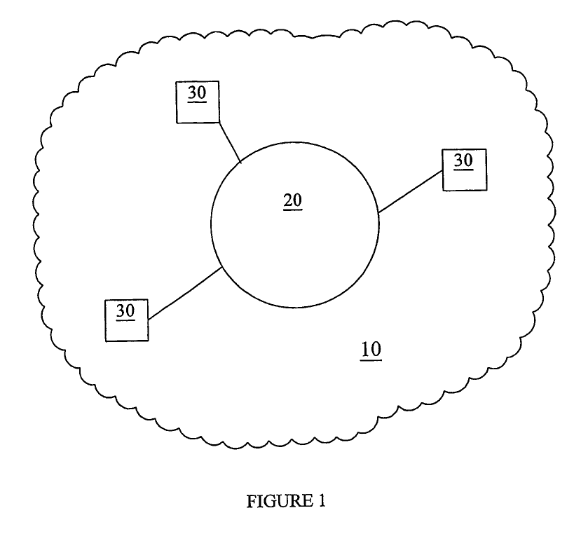

FIG. 1 is a schematic illustration of a general data communications system 10 comprising a plurality of user equipment 30 connected to a base station subsystem 20. The base station subsystem 20, comprises a plurality of base station system nodes such as either a plurality of stand-alone base stations 21 (as in e.g. W-LAN), or a plurality of base stations 21 in combination with additional nodes e.g. a packet control unit PCU and a base station controller BSC (as in e.g. GSM/GPRS/EDGE) or a radio network controller RNC (as in e.g. W-CDMA).

The invention will be discussed in context of a GPRS/EDGE data communication system, it is however implied that the same discussion can be applied to other packet-based radio systems with shared resources such as W-DCMA and W-LAN networks, or EGPRS, GPRS/EDGE, and CDMA2000.

Since the present invention only relates to the actual polling procedure in a communication system, all other functions are assumed to be performed according to common knowledge and are thus not further explained.

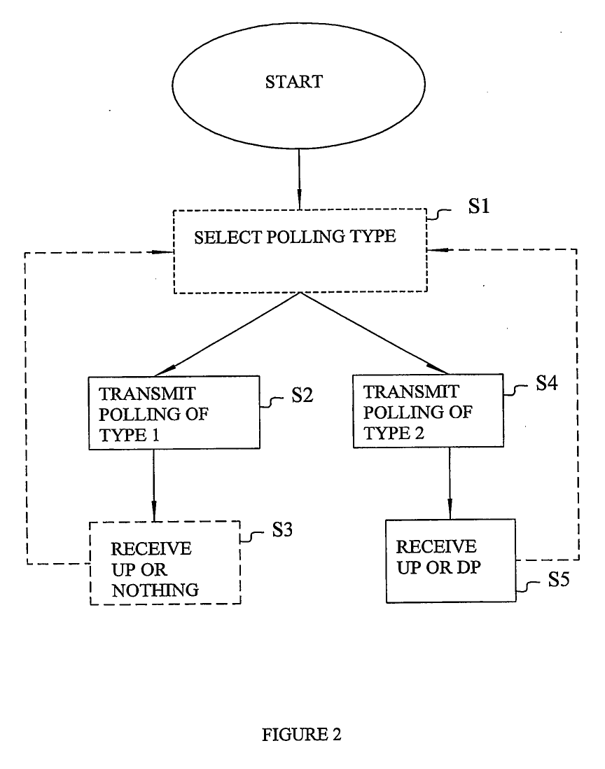

FIG. 2 is a schematic flow diagram of a method in a base station system 20 according to the invention. In step S1 the base station system 20 determines which type of polling to perform. This is typically achieved by analyzing the radio traffic situation by means of an analyzing unit 23 or by looking up information concerning the various connected user equipment in some optional register and by analyzing earlier transmissions. Then the base station system 20 performs polling according to a first type T1 in step S2 or a complementary second type T2 in step S4, by transmitting type one T1 polling or type two T2 polling to a target user equipment 30.

Alternatively the method according to FIG. 2 can comprise an additional step of performing polling according to at least a third type.

In response to polling according to type one T1 the base station system 20 receives a user data packet UP or nothing in step S3. Depending on the radio traffic situation the base station system 20 assumes that a lack of response is caused by either that the user equipment 30 has nothing to transmit or that the uplink is defective. The first assumption causes the base station system 20 to proceed according to a predetermined polling scheme, whilst the second assumption might cause the base station system 20 to choose to perform polling according to the second type T2 in order to determine if the user equipment 30 is still active or connected.

In response to polling according to the complementary type two T2 the base station system 20 receives a user data packet UP or a so called dummy data packet DP in step S5. If there is no response to the polling of type two T2 the base station assumes that the user equipment 30 has abandoned the connection, voluntary or involuntary, or that a transmitted data packet has been lost during transmission. The base station system 20 can then chose either to retract the pre-reserved radio resource or to perform an additional polling according to type two T2

The transmission of dummy data packets DP can be realized in at least three different ways. Firstly, transmitting real dummy data e.g. a string of zeros in a field for user data. Secondly, transmitting a data packet where a checksum is deliberately wrong, thereby causing the user equipment to determine the data packet to be damaged and moving it to a higher protocol level. Finally, the dummy data packet DP can be realized by re-transmitting an already sent radio block.

If the base station system 20 determines that the radio situation in the system is very noisy i.e. too much interference or that the transmission quality is very poor, it can decide to perform the type two T2 polling more frequently in order to be sure that the user equipment 30 is still connected. If there is very little interference or noise and the transmission quality is excellent the base station system 20 can decide to transmit type two T2 polling less frequently, thus assuming that the user equipment 30 stays connected.

In order to further separate the two polling types T1, T2 the base station system 20 can perform the two methods on two separate logical channels. Alternatively, the polling of type one T1 can comprise polling with an uplink state flag and the polling of type two T2 can comprise polling with a control block.

Also, in order to enable the targeted user equipment 30 to identify the type of polling, the base station system 20 can transmit polling information to the user equipment 30. This information can either be part of the actual polling or be a separated transmission preceding the polling or being managed in standard documents. Possible information is some polling scheme, e.g. identifying how often one of the polling types is expected to be sent, such as every tenth polling will be of type two T2. The polling information can be based on the current radio traffic situation in the system 10. Thereby the base station system 20 can combine the two types of polling in a manner that is optimized for the current radio traffic situation.

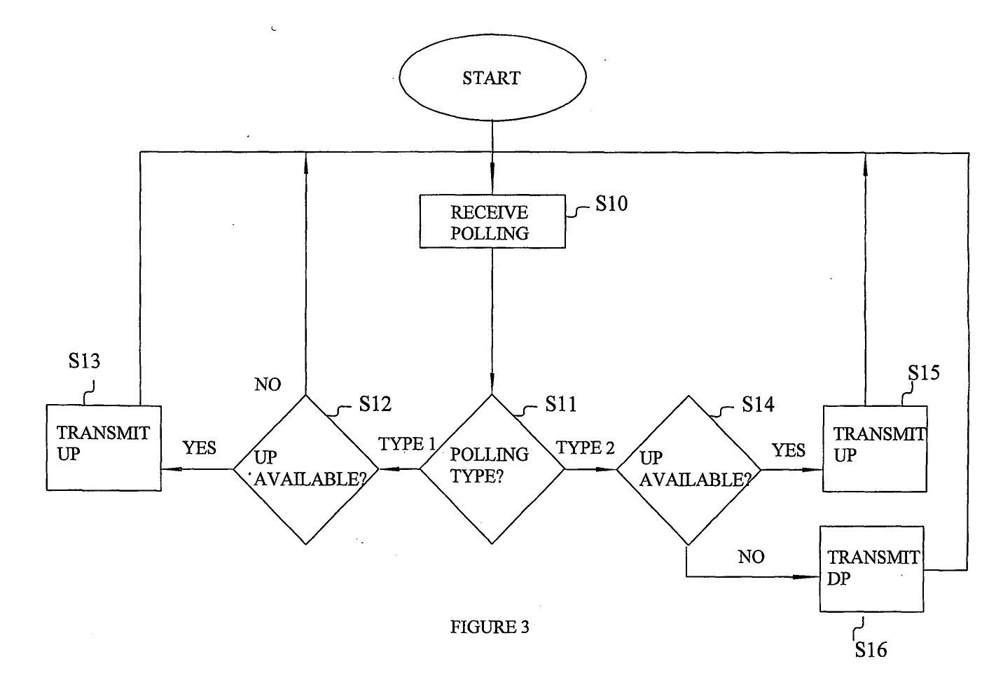

FIG. 3 is a schematic flow diagram illustrating of a method at a user equipment 30 according to the invention. Initially the user equipment 30 receives polling from a base station 21 in a base station subsystem 20 in step S10. Once the user equipment 30 receives the polling it has to identify the polling type in step 11.

If the polling is identified to be of type one T1, then step S12 checks if there are any user data packets UP in a buffer unit 33 awaiting transmission. If so user data packets UP can be transmitted to the base station system 20 in step 13. If the buffer unit 33 is empty, the user equipment 30 typically remains quiet, thus preserving the battery time. However, it may be possible for the user equipment 30 to voluntary transmit dummy data packets DP.

Alternatively the user equipment 30 can be required to transmit available user data packets UP i.e. not a voluntary transmission but a mandatory one. Similarly, that the user equipment is forbidden to send anything else than a user data packet UP in response to a polling of type one T1.

If the polling is identified as type two T2 in step S11, then step S14 checks if there are any user data packets UP in the buffer unit 33 awaiting transmission. If so such user data packets UP are transmitted to the base station system 20 in step S16. If no user data packet UP is awaiting transmission a so called dummy data packet DP is transmitted to the base station system 20 in step S17, thus confirming that the user equipment 30 is still connected.

The user data packet UP can contain actual payload data, while the dummy data packet DP can comprise data enabling the base station 21 or base station subsystem 20 to identify the user equipment 30. The dummy data packet DP can also be a retransmission of already transmitted user data.

The frequency at which the two types of polling are utilized varies with the radio traffic situation in the communications system. In order to preserve battery time for connected user equipment 30 it would be most favorable to only perform type one T1 polling, thus enabling the user equipment 30 to only transmit if there are any user data packets UP in the buffer unit 33. Unfortunately this decreases the possibility for the base station subsystem 20 to be sure if the user equipment is connected. It is therefore necessary to regularly perform type two T2 polling in order to check that the user equipment 30 is still present on the pre-reserved resource.

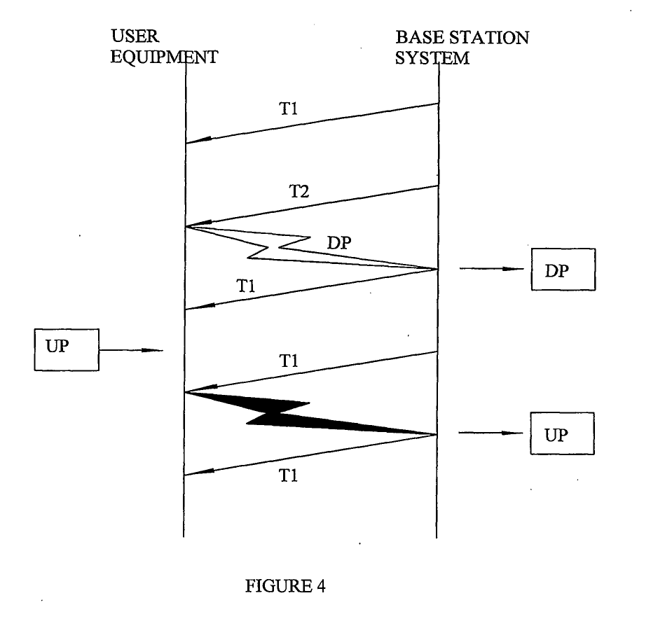

An example of a polling procedure from a base station system 20 to a user equipment 30 is illustrated in FIG. 4.

As a first step the base station subsystem performs polling according to type one T1. Since no user data packet is awaiting transmission at the user equipment, no response is transmitted.

After a time the base station system 20 performs polling according to type two T2.

Since there is still no user data packet UP awaiting transmission at the user equipment, the user equipment responds with a dummy data packet DP to the base station system 20.

The base station system 20 then performs two consecutive pollings according to type one T1.

Between those two consecutive pollings a user data packet is received at the user equipment 30 for transmission to the base station 21.

After the second polling of type one T1 the user equipment 30 responds with the user data packet UP to the base station system 20.

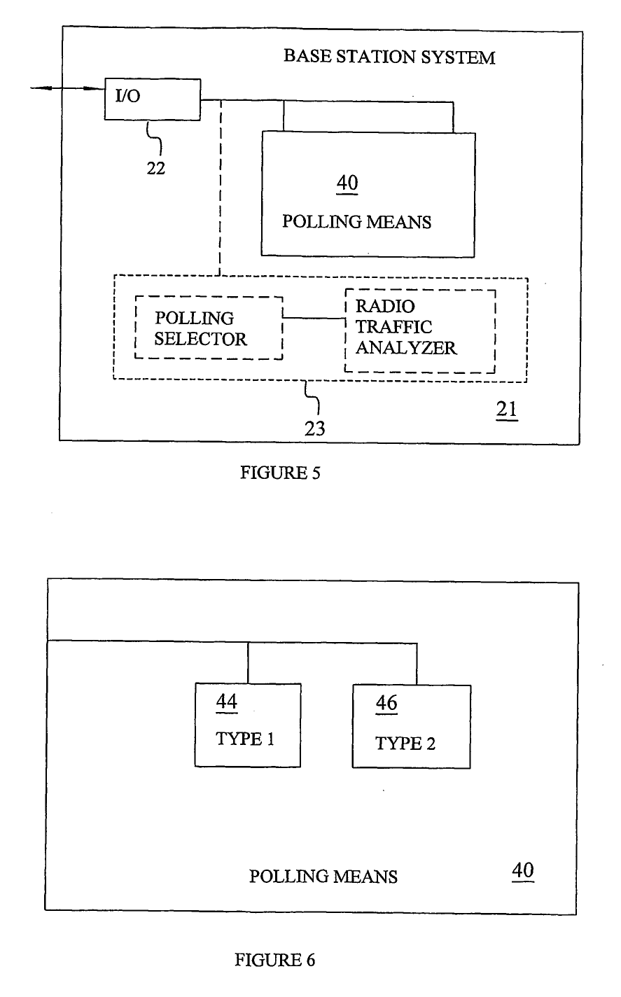

In FIG. 5 an embodiment of a base station system 20 according to the invention is shown. It comprises an input/output unit 22 for transmitting and receiving data, and polling means 40 for performing polling of user equipment 30, and optionally a unit 23 for polling selection and radio traffic analysis. The unit 23 can be a part of an actual base station 21 or optionally be in the polling means 40 or provided elsewhere in the system 20.

An embodiment of the polling means 40 according to the invention is shown in FIG. 6. It comprises first means 44 for performing polling according to a first type T1, and complementary second means 46 for performing polling according to a complementary second type T2. The first type T1 allows the targeted user equipment to transmit on a pre-reserved resource e.g. channel or frequency, if it has any user data packets to transmit. Otherwise the user equipment 30 can remain silent so as to preserve battery time. The second type T2 requires the targeted user equipment 30 to respond, either with a user data packet UP or a so called dummy data packet DP. The dummy data packet DP could in one embodiment contain information that identifies the targeted user equipment 30, thus confirming that the user equipment 30 is still connected. In another embodiment the dummy data packet DP could contain other information.

An alternative embodiment of a base station system 20 can comprise optional means for performing polling according to at least a third type.

The polling arrangement according to FIG. 6 can be optionally adapted to perform the two types of polling T1, T2 on separate logical channels.

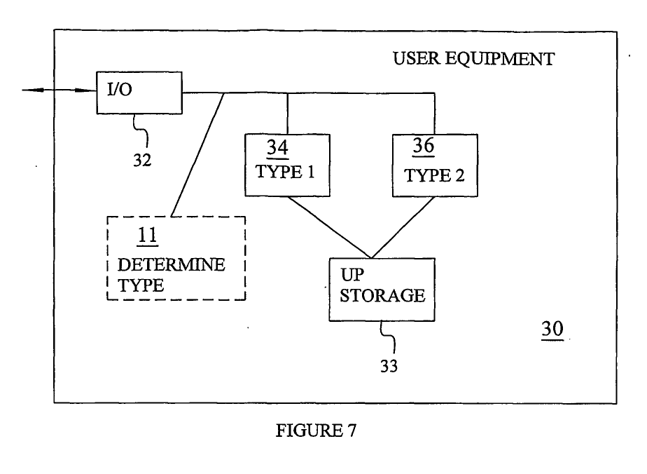

In FIG. 7 an embodiment of a user equipment 30 according to the invention is shown. The user equipment 30 comprises an input/output unit 32 for transmitting and receiving data packets, first response means 34 for receiving and responding to polling according to the first type T1, and complementary second response means 36 for responding to polling according to the second type T2, and optionally identification means 31 for identifying the polling type, and a buffer unit 33 for storing user data packets UP awaiting transmission.

An alternative embodiment of a user equipment 30 can comprise optional means for responding to polling according to at least a third type.

The user equipment 30 according to FIG. 7 can be adapted to receive polling according to type one T1 and type two T2 on two separated logical channels.

It will be understood by those skilled in the art that various modifications and changes may be made to the present invention without departure from the scope thereof, which is defined by the appended claims.

### REFERENCES

[1] 3GPP TS 44.060 V4.13.0 (2003-09)

1-29. (canceled)

30. A method of polling in a packet-based data communications system, said communications system comprising a base station system polling connected user equipment, wherein said polling is performed according to:
a first type of polling allowing said user equipment to choose whether or not to transmit a user data packet to the base station system in response to reception of polling of the first type, and
a complementary second type of polling requiring the user equipment to transmit a user data packet or a dummy data packet to the base station system in response to reception of polling of the second type.

31. A method according to claim 30, wherein said base station system performs polling according to the first type on a first logical channel, and performs polling according to the complementary second type on a second logical channel.

32. A method according to claim 30, wherein the base station system transmits poUing information to said user equipment, said information enabling the user equipment to identify the polling type of the received polling.

33. A method according to claim 32, wherein said polling information from the base station system is based on a current radio traffic situation in the communication system.

34. A method according to claim 30, wherein said first type comprises polling with an upstate flag and said second type comprises polling with a control block.

35. A method according to claim 30, wherein the communications system is selected from at least one of:
a General Packet Radio Service (GPRS) communication system, an Enhanced GPRS (EGPRS) communication system,
a GPRS/Enhanced Data rates for GSM (Global System for Mobile communications) Evolution (EDGE) communications system,
a Wideband Code Division Multiple Access (W-CDMA) communications system, a CDMA2000 communications system,
a Wireless Local Area Network (W-LAN) communications system.

36. A method according to claim 30, wherein said user equipment in response to reception of said polling of the second type transmits a user data packet to the base station system if said user data packet is available for transmission in the user equipment, otherwise the user equipment transmits the dummy data packet.

37. A method according to claim 30, wherein said user data packet comprises user payload data and said dummy data packet comprises data enabling the base station system to identify the user equipment.

38. A method according to claim 30, wherein said user equipment in response to reception of said polling of type one shall send a user data packet to the base station system if said user data packet is available for transmission in the user equipment.

39. A method according to claim 30, wherein said user equipment in response to reception of said polling of type one shall send no data packet, neither user data packet nor a dummy data packet to the base station system if said user data packet is not available for transmission in the user equipment.

40. A polling arrangement in a base station system of a packet-based communications system, said polling arrangement being adapted to polling of user equipment, wherein said arrangement comprises:
first means for polling according to a first type, allowing the user equipment to choose whether or not to transmit a user data packet in response to reception of the polling, and
complementary second means for polling according to a second type, requiring the user equipment to transmit the user data packet or a dummy data packet in response to reception of the polling.

41. A polling arrangement according to claim 40, wherein said arrangement is adapted to perform polling according to the first type on a first logical channel, and to perform polling according to the complementary second type on a second logical channel.

42. A polling arrangement according to claim 40, wherein the arrangement is adapted to transmit polling information to said user equipment, said information enabling the user equipment to identify the polling type of the received polling.

43. A polling arrangement according to claim 42, wherein the polling information is based on a current radio traffic situation in the communication system.

44. A base station system in a packet-based data communications system, said base station system being adapted to polling connected user equipment, wherein said base station system comprises
first means adapted for polling according to a first type, said first polling type allowing said user equipment to choose whether or not to transmit a user data packet to the base station system in response to reception of polling of the first type and,
complementary second means adapted for polling according to a second type, said second polling type requiring the user equipment to transmit a user data packet or a dummy data packet to the base station system in response to reception of polling of the second type.

45. A base station system according to claim 44, wherein said base station system comprises third means adapted for analyzing the current radio traffic situation in the communications system and for determining which type of polling to transmit.

46. A base station system according to claim 44, wherein said base station system is adapted to perform polling according to the first type on a first logical channel, and to perform polling according to the complementary second type on a second logical channel.

47. A base station system according to claim 44, wherein the base station system is adapted to transmit polling information to said user equipment, said information enabling the user equipment to identify the polling type of the received polling.

48. A base station system according to claim 47, wherein said polling information is based on a current radio traffic situation in the communication system.

49. A base station system according to claim 44, wherein the communications system is selected from at least one of:
a General Packet Radio Service (GPRS) communication system,
an Enhanced GPRS (EGPRS) communication system,
a GPRS/Enhanced Data rates for GSM (Global System for Mobile communications) Evolution (EDGE) communications system,
a Wideband Code Division Multiple Access (W-CDMA) communications system,
a CDMA2000 communications system,
a Wireless Local Area Network (W-LAN) communications system.

50. A base station system node in a packet-based data communications system, said node being adapted to polling connected user equipment, wherein said node comprises
first means adapted for poUing according to a first type, said first polling type allowing said user equipment to choose whether or not to transmit a user data packet to the base station system in response to reception of polling of the first type and
complementary second means adapted for polling according to a second type, said second polling type requiring the user equipment to transmit a user data packet or a dummy data packet to the base station system in response to reception of polling of the second type.

51. A user equipment in a packet-based data communications system, said user equipment being adapted to receive polling from a base station system in said communications system, wherein the user equipment comprises:
first means for receiving and responding to polling of a first type, said first means being adapted for optional transmission of a user data packet to the base station system in response to said polling, and
complementary second means for receiving and responding to polling of a second type, said second means being adapted to mandatory transmit the user data packet or a dummy data packet to the base station system in response to the polling.

52. A user equipment according to claim 51, wherein said equipment further comprises third means for identifying the polling type.

53. A user equipment according to claim 51, wherein said equipment further comprises:
a buffer unit for storing user data packets awaiting transmission.

54. A user equipment according to claim 53, wherein said first means and said second means are adapted to check if there are any user data packets in the buffer in response to polling from the base station system.

55. A user equipment according to claim 53, wherein
said first means are further adapted to receive polling according to said first type on a first logical channel, and
said second means are further adapted to receive polling according to said second type on a second logical channel.

56. A system for polling in a packet-based data communications system adapted to polling said system comprising:
means adapted for polling user equipment in said communications system according to a first type and a complementary second type,
first responding means adapted for optionally transmitting a user data packet from said user equipment to a base station system in response to reception of polling according to said first type, and
complementary second responding means adapted for obligatory transmission of the user data packet or a dummy data packet to the base station system in response to reception of polling according to said complementary second type.

57. A system according to claim 56, wherein the system further comprises: control means adapted for analyzing the radio traffic situation in the packet-based data communication system, and for selecting which type of polling to perform.

58. A system according claim 55, wherein the communications system is selected from at least one of:
a General Packet Radio Service (GPRS) communication system,
an Enhanced GPRS (EGPRS) communication system,
a GPRS/Enhanced Data rates for GSM (Global System for Mobile communications) Evolution (EDGE) communications system,
a Wideband Code Division Multiple Access (W-CDMA) communications system,
a CDMA2000 communications system,
a Wireless Local Area Network (W-LAN) communications system.
